(19) United States
(12) Patent Application Publication
(10) Pub. No.: US 2023/0015872 A1
(43) Pub. Date: Jan. 19, 2023

(54) ADJUSTABLE CUTTING AND CREASING HEADS FOR CREATING ANGLED CUTS AND CREASES

(71) Applicant: Packsize LLC, Salt Lake City, UT (US)

(72) Inventors: Niklas Pettersson, Västerås (SE); Johan Blomberg, Uppsala (SE); Bjorn Thunell, Örsundsbro (SE)

(21) Appl. No.: 17/950,271

(22) Filed: Sep. 22, 2022

Related U.S. Application Data
(63) Continuation of application No. 16/689,976, filed on Nov. 20, 2019.
(60) Provisional application No. 62/773,484, filed on Nov. 30, 2018.

(51) Int. Cl. B31D 1/00; B31B 50/20; B31B 120/30; B31B 50/25; B31B 50/26

(52) U.S. Cl. CPC B31D 1/0043; B31B 50/20; B31B 2120/302; B31B 50/25; B31B 50/26

(57) ABSTRACT

A converting machine is used to convert sheet material into packaging templates for assembly into boxes or other packaging. The converting machine includes a converting assembly that performs a transverse conversion function, a longitudinal conversion function, and an angled conversion function on the sheet material to create the packaging templates. The converting machine includes a tool head with a converting instrument. The orientation of the converting instrument is adjustable to enable performance of the angled conversion function and at least one of the longitudinal conversion function and the transverse conversion function.

### CROSS-REFERENCE TO RELATED APPLICATION

The present application is a continuation of U.S. application Ser. No. 16/689,976, filed Nov. 20, 2019, and entitled Adjustable Cutting and Creasing Heads for Creating Angled Cuts and Creases, which claims priority to and the benefit of U.S. Provisional Application No. 62/773,484, filed Nov. 30, 2018, and entitled Adjustable Cutting and Creasing Heads for Creating Angled Cuts and Creases, the entire content of each of which is incorporated herein by reference.

### BACKGROUND

### 1. Technical Field

Exemplary embodiments of the disclosure relate to systems, methods, and devices for converting sheet materials. More specifically, exemplary embodiments relate to converting machines and components thereof that can make angled cuts and/or creases in paperboard, corrugated board, cardboard, and similar sheet materials.

### 2. The Relevant Technology

Shipping and packaging industries frequently use paperboard and other sheet material processing equipment that converts sheet materials into box templates. One advantage of such equipment is that a shipper may prepare boxes of required sizes as needed in lieu of keeping on hand a stock of standard, pre-made boxes of various sizes. Consequently, the shipper can eliminate the need to forecast its requirements for particular box sizes as well as to store pre-made boxes of standard sizes. Instead, the shipper may store one or more bales of fanfold material, which can be used to generate a variety of box sizes based on the specific box size requirements at the time of each shipment. This allows the shipper to reduce storage space normally required for periodically used shipping supplies as well as reduce the waste and costs associated with the inherently inaccurate process of forecasting box size requirements, as the items shipped and their respective dimensions vary from time to time.

In addition to reducing the inefficiencies associated with storing pre-made boxes of numerous sizes, creating custom sized boxes also reduces packaging and shipping costs. In the fulfillment industry it is estimated that shipped items are typically packaged in boxes that are about 65% larger than the shipped items. Boxes that are too large for a particular item are more expensive than a box that is custom sized for the item due to the cost of the excess material used to make the larger box. When an item is packaged in an oversized box, filling material (e.g., Styrofoam, foam peanuts, paper, air pillows, etc.) is often placed in the box to prevent the item from moving inside the box and to prevent the box from caving in when pressure is applied (e.g., when boxes are taped closed or stacked). These filling materials further increase the cost associated with packing an item in an oversized box.

Customized sized boxes also reduce the shipping costs associated with shipping items compared to shipping the items in oversized boxes. A shipping vehicle filled with boxes that are 65% larger than the packaged items is much less cost efficient to operate than a shipping vehicle filled with boxes that are custom sized to fit the packaged items. In other words, a shipping vehicle filled with custom sized packages can carry a significantly larger number of packages, which can reduce the number of shipping vehicles required to ship the same number of items. Accordingly, in addition or as an alternative to calculating shipping prices based on the weight of a package, shipping prices are often affected by the size of the shipped package. Thus, reducing the size of an item's package can reduce the price of shipping the item. Even when shipping prices are not calculated based on the size of the packages (e.g., only on the weight of the packages), using custom sized packages can reduce the shipping costs because the smaller, custom sized packages will weigh less than oversized packages due to using less packaging and filling material.

Although sheet material processing machines and related equipment can potentially alleviate the inconveniences associated with stocking standard sized shipping supplies and reduce the amount of space required for storing such shipping supplies, previously available machines and associated equipment have various drawbacks or limitations. For instance, typical box making machines have been limited in the types of box templates that can be formed therewith. By way of example, typical box making machines include cutting and/or creasing tools that form cuts or creases in only longitudinal and transverse directions (relative to the sheet material used to make the box templates) that are oriented parallel or perpendicular to one another. As a result, the machines have only been able to make box templates that require cuts and/or crease that are parallel and/or perpendicular to one another. Such machines have not been able to make angled cuts or creases (e.g., that extend diagonally across the sheet material). In order to make box templates that require angled cuts or creases, specialty machines have been required, which increase the expense associated with making boxes of various types.

Accordingly, there remains room for improvement in the area of sheet material processing machines.

### BRIEF SUMMARY

Exemplary embodiments of the disclosure relate to systems, methods, and devices for converting sheet materials into boxes. More specifically, exemplary embodiments relate to converting machines and components thereof that can make angled cuts and/or creases in paperboard, corrugated board, cardboard, and similar sheet materials.

For instance, one embodiment is directed to a converting machine used to convert sheet material into packaging templates for assembly into boxes or other packaging. The converting machine includes a converting assembly configured to perform a transverse conversion function, a longitudinal conversion function, and an angled conversion function on the sheet material as the sheet material moves through the converting machine in a feed direction. The transverse conversion function, the longitudinal conversion function, and the angled conversion function are selected from the group consisting of creasing, bending, folding, perforating, cutting, and scoring, to create the packaging templates. The converting assembly includes a tool head that is selectively movable between opposing sides of the converting assembly. The tool head includes one or more converting instruments for performing the angled conversion function and at least one of the transverse conversion function or the longitudinal conversion function. An orientation of the one or more converting instruments is selectively adjustable between a default orientation and an angled orientation.

In some embodiments, the one or more converting instruments are configured to perform the angled conversion function when the one or more converting instruments are in the angled orientation. In contrast, the one or more converting instruments are configured to perform the transverse conversion function or the longitudinal conversion function when the one or more converting instruments are in the default orientation.

In some embodiments, the tool head includes a mounting block and a frame connected thereto. The one or more converting instruments are connected to the frame and the frame is adjustable about a first axis to reorient the one or more converting instruments between the default orientation and the angled orientation. The mounting block, the frame, and the one or more converting instruments can also be adjustable about a second axis to reorient the one or more converting instruments between the default orientation and the angled orientation.

The converting machine can also include a feed roller that advances the sheet material through the converting assembly. A control system that is configured to control the operation of the feed roller and the tool head can also be included. The control system can synchronize a speed of the feed roller and movements of the tool head.

In some embodiments, the angled conversion function is formed diagonally across the sheet material, while in other embodiments the angled conversion function is formed at an angle through the sheet material. In some cases, the angled conversion function includes curved cuts or creases formed in the sheet material.

The converting machine can also include a second tool head having one or more converting instruments for performing the angled conversion function and at least one of the transverse conversion function or the longitudinal conversion function. An orientation of the one or more converting instruments can be selectively adjustable between a default orientation and an angled orientation. In some cases, the tool head comprises a long head and the second tool head comprises a cross head. The one or more converting instruments of the long head can have a default orientation that is generally parallel to the feed direction of the sheet material and the one or more converting instruments of the cross head can have a default orientation that is generally perpendicular to the feed direction of the sheet material. The tool head can perform the longitudinal conversion function and the angled conversion function, and the second tool head can perform the transverse conversion function.

In other embodiments, a converting machine used to convert sheet material into packaging templates for assembly into boxes or other packaging includes a converting assembly configured to perform longitudinal conversion functions on the sheet material as the sheet material moves through the converting machine in a feed direction. The longitudinal conversion functions including at least one of creasing, bending, folding, perforating, cutting, and scoring, to create the packaging templates. The converting assembly includes a tool head selectively movable between opposing sides of the converting assembly. The tool head comprises one or more converting instruments for performing the longitudinal conversion functions. A position of the tool head is selectively adjustable in a direction generally perpendicular to the length of the sheet material and while the sheet material is advancing through the converting assembly.

These and other objects and features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a perspective view of an exemplary embodiment of a system for creating packaging templates;

FIG. 2 illustrates a perspective view of a portion of a converting assembly from the system illustrated in FIG. 1;

FIG. 3 is partial top view of a tool head performing angled conversion functions on sheet material;

FIG. 4 illustrates a tool head performing an angled conversion function on sheet material; and

FIG. 5 illustrates a perspective view of another portion of the converting assembly from the system illustrated in FIG. 1.

### DETAILED DESCRIPTION

The embodiments described herein generally relate to systems, methods, and devices for processing sheet materials and converting the same into packaging templates. More specifically, the described embodiments relate to converting machines or components thereof for converting sheet materials (e.g., paperboard, corrugated board, cardboard) into templates for boxes and other packaging.

While the present disclosure will describe details of embodiments with reference to specific configurations, the descriptions are illustrative and are not to be construed as limiting the scope of the present invention. Various modifications can be made to the illustrated configurations without departing from the spirit and scope of the invention as defined by the claims. For better understanding, like components have been designated by like reference numbers throughout the various accompanying figures.

As used herein, the terms “box template” and “packaging template” shall refer to a substantially flat stock of material that can be folded into a box-like shape. A box or packaging template may have notches, cutouts, divides, and/or creases that allow the box or packaging template to be bent and/or folded into a box. Additionally, a box or packaging template may be made of any suitable material, generally known to those skilled in the art. For example, cardboard or corrugated paperboard may be used as the template material. A suitable material also may have any thickness and weight that would permit it to be bent and/or folded into a box-like shape.

As used herein, the term “crease” shall refer to a line along which the sheet material or box template may fold. For example, a crease may be an indentation in the sheet material. In the case of fanfold creases, the indentation may be made by folding the sheet material into layered stacks in a bale. Other creases may be formed in the sheet material to aid in folding portions of the sheet material separated by the crease, with respect to one another, to form a box.

The terms “notch,” “cutout,” and “cut” are used interchangeably herein and shall refer to a shape created by removing material from the template or by separating portions of the template, such that a divide through the template is created.

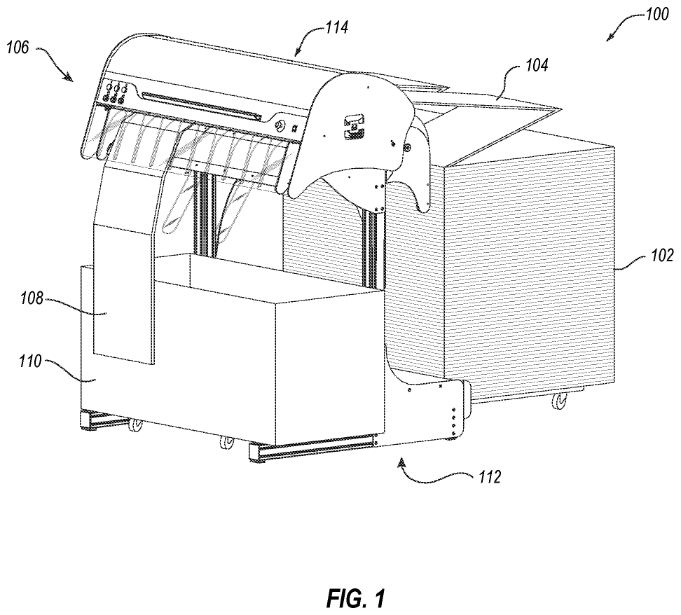

FIG. 1 illustrates a perspective view of a system 100 that may be used to create packaging templates. System 100 includes one or more bales 102 of sheet material 104. System 100 also includes a converting machine 106 that performs one or more conversion functions on sheet material 104, as described in further detail below, in order to create packaging templates 108. Excess or waste sheet material 104 produced during the conversion process may be collected in a collection bin 110. After being produced, packaging templates 108 may be formed into packaging containers, such as boxes.

As illustrated in FIG. 1, converting machine 106 includes a support structure 112 and a converting assembly 114 mounted on support structure 112. Bales 102 may be disposed proximate to the backside of converting machine 106, and sheet material 104 may be fed into converting assembly 114. Sheet material 104 may be arranged in bales 102 in multiple stacked layers. The layers of sheet material 104 in each bale 102 may have generally equal lengths and widths and may be folded one on top of the other in alternating directions.

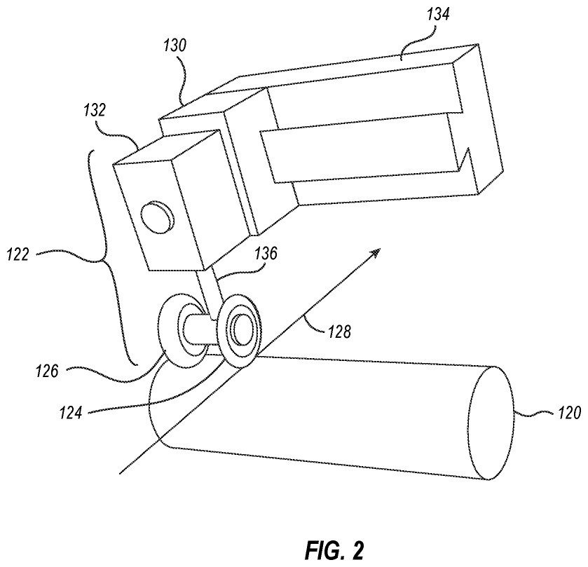

As sheet material 104 is fed through converting assembly 114, converting assembly 114 may perform one or more conversion functions (e.g., crease, bend, fold, perforate, cut, score) on sheet material 104 in order to create packaging templates 108. As shown in FIGS. 2-5 and described below, converting assembly 114 may include components that feed sheet material 104 through converting assembly 114 and perform the conversion functions thereon.

For example, FIG. 2 illustrates some example components of converting assembly 114. Included in converting assembly 114 is a feed roller 120 that pulls sheet material 104 into converting assembly 114 and advances sheet material 104 therethrough. Feed roller 120 may be configured to pull sheet material 104 with limited or no slip and may be smooth, textured, dimpled, and/or teethed. Feed roller 120 may be actively rolled by an actuator or motor in order to advance sheet material 104 through converting assembly 114. While FIG. 2 illustrates a single feed roller, it will be appreciated that converting assembly 114 may include multiple feed rollers.

As also illustrated in FIG. 2, converting assembly 114 also includes a tool head 122. In some embodiments, tool head 122 may also be referred to as long head 122. Tool head 122 is configured to perform the conversion functions (e.g., crease, bend, fold, perforate, cut, score) on sheet material 104 in order to create packaging templates 108 therefrom. To enable tool head 122 to be able to perform the conversion functions, tool head 122 includes a cutting wheel 124 and a creasing wheel 126. In other embodiments, a tool head may only include a cutting wheel 124 (and not a creasing wheel 126) or a creasing wheel 126 (and not a cutting wheel 124). In still other embodiments, a tool head may include one or more cutting wheels and creasing wheels. In yet other embodiments, converting assembly 114 may include separate tool heads for cutting wheel(s) 124 and creasing wheel(s) 126.

Cutting and/or creasing wheels 124, 126 may be selectively positioned to engage sheet material 104 as sheet material 104 advances through converting assembly 114 in order to perform the conversion functions thereon. For instance, in some embodiments, tool head 122 enables cutting and/or creasing wheels 124, 126 to be raised and lowered (relative to feed roller 120) to disengage and engage sheet material 104. In the illustrated embodiment, tool head 122 is positioned relative to feed roller 120 so that sheet material 104 advances between feed roller 120 and cutting and creasing wheels 124, 126. Feed roller 104 may also support sheet material 104 while tool head 122 performs the conversion functions thereon. In other embodiments, converting assembly 114 may include a support surface (separate from feed roller 134) for supporting sheet material 104 while conversion functions are performed thereon.

In the default position shown in FIG. 2, cutting and creasing wheels 124, 126 are oriented parallel to the feed direction of sheet material 104. The feed direction of sheet material 104 is illustrated by arrow 128. In this orientation, conversion functions may be made on sheet material 104 in a direction substantially parallel to the direction of movement and/or the length of sheet material 104. Conversions made along the length of and/or generally parallel to the direction of movement of sheet material 104 may be considered “longitudinal conversions.”

Tool head 122 may be used to create the longitudinal conversions on sheet material 104. More specifically, tool head 122 may be selectively repositioned along the width of converting assembly 114 (e.g., back and forth in a direction that is perpendicular to the length of sheet material 104) in order to properly position tool head 122 relative to the sides of sheet material 104. By way of example, if a longitudinal crease or cut needs to be made two inches from one edge of sheet material 104 (e.g., to trim excess material off of the edge of sheet material 104), tool head 122 may be moved perpendicularly across sheet material 104 to properly position cutting wheel 124 and/or creasing wheel 126 so as to be able to make the cut or crease at the desired location. In other words, tool head 122 may be moved transversely across sheet material 104 to position tool head 122 at the proper locations to make the longitudinal conversions on sheet material 104.

In addition to being able to be positioned at a desired location in order to perform a conversion function at a desired location on sheet material 104, the position of tool head 122 may also be adjusted while sheet material 104 is being advanced through converting assembly 114. By way of example, tool head 122 may be moved so that creasing wheel 126 can perform a creasing function at a predetermined location on sheet material 104. After creasing wheel 126 has performed the creasing function at the predetermined location and along a predetermined length of sheet material, the position of tool head 122 may be adjusted so that creasing wheel 126 can perform a creasing function on a different predetermined location and along a second length of sheet material 104. Similarly, the position of tool head 122 may be adjusted while the sheet material 104 is being advanced through the converting assembly 114 so as to enable the cutting wheel 124 to form offset cuts along different lengths of the sheet material 104.

In some embodiments, the positional adjustment of tool head 122 may be made while sheet material 104 is still being advanced through converting assembly 114. For instance, the positional adjustment to tool head 122 may be made while the sheet material is moving or continuously moving through the converting assembly 114. Additionally, the positional adjustments of tool head 122 may be made while cutting wheel 124 and/or creasing wheel 126 are in the default orientation shown in FIG. 2 (e.g., oriented parallel to the length of sheet material 104).

The length of such positional adjustments may correspond to a thickness of one or more layers of sheet material 104. In some embodiments, for instance, creasing wheel 126 may be positioned to perform a creasing function at a first position along a first length of sheet material 104. Thereafter, the position of creasing wheel 126 may be adjusted a distance that corresponds to the thickness of, for example, one or two layers of sheet material 104. At the adjusted position, creasing wheel 126 may be positioned to perform a creasing function at a second position along a second length of sheet material 104. The creases formed at the first and second positions may facilitate folding of the resulting box template into a completed box. For instance, the offset creases may allow one panel or flap of the resulting box template to be folded either inside or outside of another panel or flap of the box template when forming a box therefrom.

To enable tool head 122 to move transversely across sheet material 104, a carriage 130 is connected to a mounting block 132 of tool head 122. Carriage 130 is slidably connected to a track 134. Track 134 is oriented transverse (i.e., perpendicular) to the feed direction 128 of sheet material 104. As a result, when carriage 130 moves along the length of track 134, tool head 122 is transversely repositioned along the width of sheet material 104.

In addition to being able to make longitudinal conversions, tool head 122 may be configured to make angled conversions in sheet material 104. By way of example, cutting wheel 124 and/or creasing wheel 126 may be mounted on a frame 136 that can rotate so that the orientation of cutting wheel 124 and/or creasing wheel 126 can be adjusted. Rotation of frame 136 can enable cutting wheel 124 and/or creasing wheel 126 to be oriented at a non-parallel angle relative to feed direction 128.

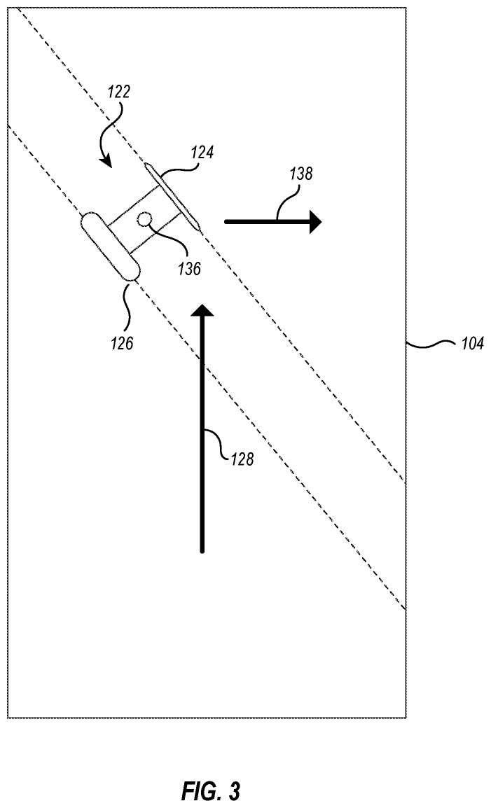

FIG. 3 illustrates a plan view of sheet material 104 and cutting and creasing wheels 124, 126. As can be seen, cutting and creasing wheels 124, 126 have been rotated about an axis of frame 136. As a result, cutting and creasing wheels 124, 126 are oriented at an angle (e.g., not parallel) relative to feed direction 128 of sheet material 104. When cutting and/or creasing wheels 124, 126 are so angled, cutting and/or creasing wheels 124, 126 can perform conversion functions that are angled across on sheet material 104.

In order for cutting and/or creasing wheels 124, 126 to perform the angled conversion functions, sheet material 104 is advanced through converting assembly 114 and tool head 122 is simultaneously moved transversely across sheet material 104. The combined movements of sheet material 104 in feed direction 128 and tool head 122 transverse thereto (e.g., in the direction of arrow 138), as well as the angled orientation of cutting and/or creasing wheels 124, 126, enables angled conversions (illustrated in FIG. 3 with dashed lines) to be performed on sheet material 104.

FIG. 3 illustrates cutting and/or creasing wheels 124, 126 angled in a first direction and tool head 122 moving in the direction of arrow 138 so as to perform a conversion function in a first diagonal direction. It will be understood that cutting and/or creasing wheels 124, 126 can be angle in an opposite direction and tool head 122 can move in a direction opposite to arrow 138 so as to perform a conversion function in a second diagonal direction. Furthermore, it will be appreciated that cutting and/or creasing wheels 124, 126 can be angled at substantially any angle relative to feed direction 128 so as to perform conversion functions at substantially any angle across sheet material 104.

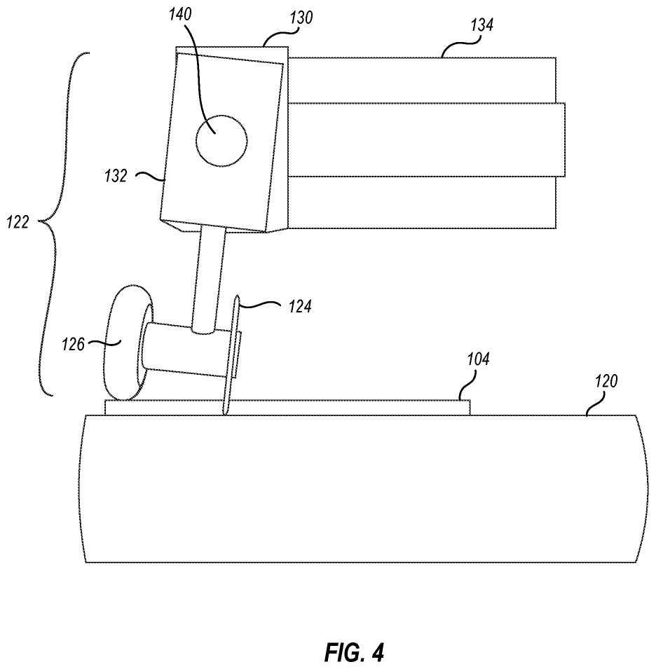

While FIG. 3 illustrates cutting and creasing wheels 124, 126 being angled to enable angled conversions across sheet material 104, tool head 122 may also be configured to enable angled conversions through sheet material 104. By way of example, tool head 122 (or portions thereof) may rotate around pin 140 so as to angle cutting and/or creasing wheels 124, 126 relative to a planar surface of sheet material 104. As shown in FIG. 4, for instance, tool head 122 is rotated about pin 140 so that cutting wheel 124 cuts through sheet material 104 at an angle. More specifically, cutting wheel 124 is angled so that the resulting cut through sheet material 104 is angled between the opposing planar faces of sheet material 104. It will be appreciated that the direction and degree of the conversion function can vary between substantially any direction and/or degree.

While FIGS. 2-4 and the foregoing description have disclosed a single tool head that can be adjusted to perform various angled conversions on sheet material 104, it will be appreciated that converting assembly 114 may include a plurality of such tool heads. It will also be appreciated that converting assembly 114 may include multiple adjustable tool heads. For instance, a converting assembly may include one or more adjustable tool heads than can perform angled conversions in a first direction or orientation and one or more other adjustable tool heads that can perform angled conversions in a second direction or orientation.

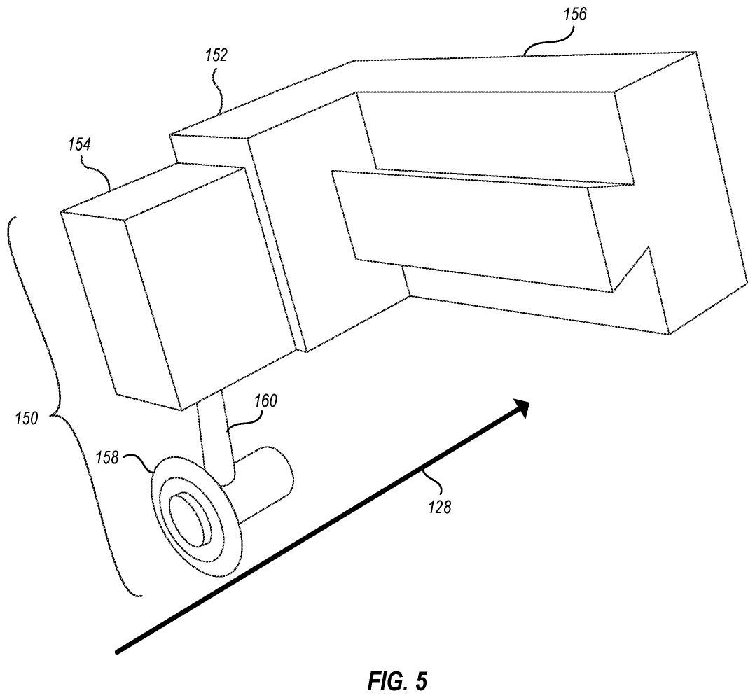

Furthermore, FIGS. 2-4 and the foregoing description have focused on a tool head that can perform both longitudinal conversions and can be reoriented to perform angled conversions across and/or through sheet material 104. As noted above, such a tool head may also be referred to as a long head since it performs longitudinal conversions. As illustrated in FIG. 5, converting assembly 114 may also include one or more tool heads 150 that can perform both “transverse conversions” and can be reoriented to perform angled conversions across and/or through sheet material 104. Such a tool head 150 may also be referred to as cross head 150 since it performs transverse conversions across sheet material 104 (e.g., conversion functions performed in a direction substantially perpendicular to the direction of movement and/or the length of sheet material 104).

To perform the transverse conversions, tool head 150 may move along at least a portion of the width of converting assembly 114 in a direction generally perpendicular to feed direction 128 (the direction in which sheet material 104 is fed through converting assembly 114 and/or the length of sheet material 104). In other words, tool head 150 may move across sheet material 104 in order to perform transverse conversions on sheet material 104.

To enable tool head 150 to move transversely across sheet material 104, a carriage 152 is connected to a mounting block 154 of tool head 150. Carriage 152 is slidably connected to a track 156. Track 156 is oriented transverse (i.e., perpendicular) to the feed direction 128 of sheet material 104. As a result, when carriage 152 moves along the length of track 156, tool head 152 moves transversely across sheet material 104.

Tool head 150 may include one or more converting instruments, such as a cutting wheel 158 and/or a creasing wheel, which may perform one or more transverse conversions on sheet material 104. For example, as tool head 150 moves back and forth over sheet material 104, cutting wheel 158 and/or a creasing wheel may create creases, bends, folds, perforations, cuts, and/or scores in sheet material 104.

In addition to being able to move transversely across sheet material 104 in order to perform transverse conversion functions at a desired location on sheet material 104, the sheet material 104 may be incrementally advanced through the converting assembly 114 while tool head 150 is moved transversely across sheet material 104. By way of example, tool head 150 may be moved across sheet material 104 so that cutting wheel 158 forms a transverse cut at a desired location in sheet material 104. After tool head 150 has performed the conversion function at the predetermined location and along a predetermined width of sheet material 104, sheet material 104 may be adjusted (e.g., incrementally advanced through the converting assembly 114) so that tool head 150 can perform a conversion function on a different predetermined location and along a second width of sheet material 104.

In some embodiments, the incremental advancement of sheet material 104 may be made while tool head 105 is still moving across sheet material 104. For instance, the incremental advancement of sheet material 104 may be made while tool head 105 is moving or continuously moving across sheet material 104. Additionally, the incremental advancement of sheet material 104 may be made while cutting wheel 58 and/or a creasing wheel is in the default orientation shown in FIG. 5 (e.g., oriented perpendicular to the length of sheet material 104).

The length of such incremental advancements of sheet material 104 may correspond to a thickness of one or more layers of sheet material 104. In some embodiments, for instance, sheet material 104 may be positioned so that cutting wheel 158 and/or a creasing wheel can perform a conversion function at a first position along a first width of sheet material 104. Thereafter, sheet material 104 may be incrementally advanced a distance that corresponds to the thickness of, for example, one or two layers of sheet material 104. With the sheet material 104 in the incrementally advanced position, cutting wheel 158 and/or a creasing wheel may continue to advance across sheet material 104 to perform a conversion function at a second position along a second width of sheet material 104.

Similar to tool head 122, tool head 150 can be configured so that the orientation of cutting wheel 158 and/or a creasing wheel can be selectively adjusted. By way of example, cutting wheel 158 and/or a creasing wheel may be mounted on a frame 160 that can rotate so that the orientation of cutting wheel 158 and/or a creasing wheel can be adjusted. Rotation of frame 160 can enable cutting wheel 158 and/or a creasing wheel to be oriented at a non-perpendicular angle relative to feed direction 128. When cutting wheel 158 and/or a creasing wheel is oriented at a non-perpendicular angle relative to feed direction 128, cutting wheel 158 and/or a creasing wheel can perform angled conversion functions on sheet material 104.

In order for cutting wheel 158 and/or a creasing wheel to perform the angled conversion functions, sheet material 104 is advanced through converting assembly 114 and tool head 150 is simultaneously moved transversely across sheet material 104. The combined movements of sheet material 104 in feed direction 128 and tool head 150 transverse thereto (e.g., perpendicular to feed direction 128), as well as the angled orientation of cutting wheel 158 and/or a creasing wheel, enables angled conversions to be performed on sheet material 104.

Although not illustrated in FIG. 5, tool head 150 (or portions thereof) may also be adjustable to enable cutting wheel 158 to perform angled cuts through sheet material 104, similar to the discussion of the embodiment shown in FIG. 4.

The orientation of the various tool heads and/or converting instruments thereof (e.g., cutting wheels, creasing wheels, etc.) may be adjusted on the fly (e.g., as conversion functions are being performed). On the fly adjustments to these components can increase the speed at which the conversion functions are performed, thereby reducing or eliminating the need to stop the feeding of the sheet material while adjustments are made. Furthermore, the adjustability of the noted components can enable diagonal and/or curved conversions to be made in the sheet material. Such capability can allow for a wider range of box templates to be formed and/or for additional functionality to be incorporated in the boxes formed with the box templates.

The converting instruments (e.g., cutting wheels, creasing wheels, etc.) described herein may be passive or active. For instance, a cutting or creasing wheel may freely rotate as the sheet material is advanced thereby. In other cases, a cutting wheel or creasing wheel may be actively driven (e.g., with a motor or other actuator). Additionally, the tool heads may include actuators, motors, gears, etc. to reorient the converting instruments to the desired angle.

A control system can control the operation of the converting machine 106. More specifically, the control system can control the movement and/or placement of the various components of the converting machine 106. For instance, the control system can control the rotational speed and/or direction of the feed rollers 134 in order to govern the direction (i.e., forward or backward) the sheet material 104 is fed and/or the speed at which the sheet material 104 is fed through the converting machine 106. The control system can also govern the positioning and/or movement of the tool heads 122, 150, including the orientation of cutting wheels 124, creasing wheels 126, and cutting wheels 158, so that the tool heads 122, 150 perform the conversion functions in the desired orientations and on the desired locations of the sheet material 104. The control system can also synchronize the operations of the feed rollers 134 (e.g., speed and direction), tool heads 122, 150 (position, movement, and direction), and the orientation of the cutting wheels 124, creasing wheels 126, and cutting wheels 158 so that the desired conversion functions are performed.

The control system may be incorporated into converting machine 106. In other embodiments, converting machine 106 may be connected to and in communication with a separate control system, such as a computer, that controls the operation of converting machine 106. In still other embodiments, portions of the control system may be incorporated into converting machine 106 while other portions of the control system are separate from converting machine 106. Furthermore, the control system may include hardware components, software components, or combinations thereof. Regardless of the specific configuration of the control system, the control system can control the operations of converting machine 106 that form box templates 108 out of sheet material 104.

It will be appreciated that relative terms such as “horizontal,” “vertical,” “upper,” “lower,” “raised,” “lowered,” “above,” “below” and the like, are used herein simply by way of convenience. Such relative terms are not intended to limit the scope of the present invention. Rather, it will be appreciated that the components described herein may be configured and arranged such that these relative terms require adjustment.

The present invention may be embodied in other specific forms without departing from its spirit or essential characteristics. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A converting machine used to convert sheet material into packaging templates for assembly into boxes or other packaging, the converting machine comprising:
a converting assembly configured to perform a transverse conversion function, a longitudinal conversion function, and an angled conversion function on the sheet material as the sheet material moves through the converting machine in a feed direction, the transverse conversion function, the longitudinal conversion function, and the angled conversion function being selected from the group consisting of creasing, bending, folding, perforating, cutting, and scoring, to create the packaging templates, the converting assembly comprising:
a tool head selectively movable between opposing sides of the converting assembly, the tool head comprising one or more converting instruments configured to perform the angled conversion function and at least one of the transverse conversion function or the longitudinal conversion function, an orientation of the one or more converting instruments being selectively adjustable between a default orientation and an angled orientation, the default orientation being either parallel or perpendicular to the feed direction of the sheet material and the angled orientation being neither parallel nor perpendicular to the feed direction of the sheet material.

2. The converting machine of claim 1, wherein the one or more converting instruments are configured to perform:
the angled conversion function when the one or more converting instruments are in the angled orientation; and/or
the transverse conversion function or the longitudinal conversion function when the one or more converting instruments are in the default orientation.

3. The converting machine of claim 1, wherein the tool head comprises a mounting block and a frame connected thereto, the one or more converting instruments being connected to the frame, wherein the frame is adjustable about a first axis to reorient the one or more converting instruments between the default orientation and the angled orientation.

4. The converting machine of claim 3, wherein the mounting block, the frame, and the one or more converting instruments are adjustable about a second axis to reorient the one or more converting instruments between the default orientation and the angled orientation.

5. The converting machine of claim 1, further comprising:
a feed roller that is configured to advance the sheet material through the converting assembly;
a control system that is configured to control the operation of the feed roller and the tool head,
wherein the control system synchronizes a speed of the feed roller and movements of the tool head.

6. The converting machine of claim 1, wherein the one or more converting instruments comprise a cutting wheel or a creasing wheel.

7. The converting machine of claim 1, wherein:
in the default orientation, the one or more converting instruments are generally parallel to the feed direction of the sheet material; and/or
in the default orientation, the one or more converting instruments are generally perpendicular to the feed direction of the sheet material.

8. The converting machine of claim 1, further comprising a carriage connected to the tool head and a track, the carriage being slidable along the track to move the tool head.

9. The converting machine of claim 1, wherein the angled conversion function is formed:
diagonally across the sheet material; and/or
at an angle through the sheet material.

10. The converting machine of claim 1, wherein the angled conversion function comprises curved cuts or creases formed in the sheet material.

11. A converting machine used to convert sheet material into packaging templates for assembly into boxes or other packaging, the converting machine comprising:
a converting assembly configured to perform a transverse conversion function, a longitudinal conversion function, and an angled conversion function on the sheet material as the sheet material moves through the converting machine in a feed direction, the transverse conversion function, the longitudinal conversion function, and the angled conversion function being selected from the group consisting of creasing, bending, folding, perforating, cutting, and scoring, to create the packaging templates, the converting assembly comprising:
a first tool head selectively movable between opposing sides of the converting assembly, the tool head comprising one or more converting instruments configured to perform the angled conversion function and at least one of the transverse conversion function or the longitudinal conversion function, an orientation of the one or more converting instruments being selectively adjustable between a default orientation and an angled orientation, the default orientation being either parallel or perpendicular to the feed direction of the sheet material and the angled orientation is neither parallel nor perpendicular to the feed direction of the sheet material; and
a second tool head comprising one or more converting instruments for performing the angled conversion function and at least one of the transverse conversion function or the longitudinal conversion function, an orientation of the one or more converting instruments being selectively adjustable between a default orientation and an angled orientation, the default orientation being either parallel or perpendicular to the feed direction of the sheet material and the angled orientation is neither parallel nor perpendicular to the feed direction of the sheet material.

12. The converting machine of claim 11, wherein the first tool head comprises a long head and the second tool head comprises a cross head, wherein, in the default orientations, the one or more converting instruments of the long head are generally parallel to the feed direction of the sheet material and the one or more converting instruments of the cross head are generally perpendicular to the feed direction of the sheet material.

13. The converting machine of claim 12, wherein the first tool head performs the longitudinal conversion function and the angled conversion function, and the second tool head performs the transverse conversion function.

14. The converting machine of claim 11, wherein, when the one or more converting instruments of the first tool head are in the default orientation, a position of the first tool head is selectively adjustable in a direction generally perpendicular to the length of the sheet material and while the sheet material is advancing through the converting assembly.

15. A converting machine used to convert sheet material into packaging templates for assembly into boxes or other packaging, the converting machine comprising:
a converting assembly configured to perform longitudinal conversion functions on the sheet material as the sheet material moves through the converting machine in a feed direction, the longitudinal conversion functions including at least one of creasing, bending, folding, perforating, cutting, and scoring, to create the packaging templates, the converting assembly comprising:
a tool head selectively movable between opposing sides of the converting assembly, the tool head comprising one or more converting instruments for performing the longitudinal conversion functions, a position of the tool head being selectively adjustable in a direction generally perpendicular to the length of the sheet material and while the sheet material is advancing through the converting assembly.

16. The converting machine of claim 15, wherein a length of the positional adjustments of the tool head generally corresponds to a thickness of one or two layers of the sheet material.

17. The converting machine of claim 15, wherein the one or more converting instruments have a default orientation in which the one or more converting instruments are generally parallel to the feed direction of the sheet material or perform the longitudinal conversion functions generally parallel to the feed direction of the sheet material.

18. The converting machine of claim 17, wherein the one or more converting instruments are selectively adjustable from the default orientation to an angled orientation to perform one or more angled conversion functions on the sheet material, wherein, in the angled orientation, the one or more converting instruments are oriented at a non-parallel and non-perpendicular angle relative to the feed direction of the sheet material.

19. The converting machine of claim 15, further comprising a second tool head having one or more converting instruments for performing one or more transverse conversion functions.

20. The converting machine of claim 19, wherein the converting assembly is configured to incrementally advance the sheet material therethrough as the one or more converting instruments of the second tool head perform the one or more conversion functions on the sheet material.
